(19) United States
(12) Patent Application Publication
(10) Pub. No.: US 2015/0331864 A1
(43) Pub. Date: Nov. 19, 2015

(54) RANKING AND RATING SYSTEM AND METHOD UTILIZING A COMPUTER NETWORK

(71) Applicants: Eric Lucas, St. Louis Park, MN (US); Rachel Lauren Clark, Toronto (CA)

(72) Inventors: Eric Lucas, St. Louis Park, MN (US); Rachel Lauren Clark, Toronto (CA)

(21) Appl. No.: 14/277,617

(22) Filed: May 14, 2014

(51) Int. Cl. G06F 17/30

(52) U.S. Cl. CPC G06F 17/3053; G06F 17/30864; G06F 17/30156; G06Q 50/01

(57) ABSTRACT

A ranking and rating system and method is disclosed. The ranking or rating system and method comprises aggregating information or data; storing the information or data; analyzing the information or data; creating a preliminary result; removing duplicates of the preliminary results; allowing users to input their custom requirements; providing a final result; and adjusting the final result to allow the system to incorporate past results in future analyses.

This application claims the benefit of the earlier filing date of, and contains subject matter related to that disclosed in U.S. Provisional Application Ser. No. 61/823,056 filed May 14, 2013, the entire contents of which is incorporated herein by reference.

Accompanying this disclosure is a computer program listing appendix containing the computer code necessary to practice the described invention. The software code in the computer program listing appendix is incorporated and made part of this patent document. At the end of the written specification, the computer program listing appendix files are identified by their names.

The computer program listing appendix and its associated files, and portions of this disclosure are subject to copyright protection and any use thereof, other than as part of the reproduction of the patent document or the patent disclosure, is strictly prohibited. The copyright owner has no objection to the facsimile reproduction by anyone of the patent document, or the patent disclosure, as it appears in the Patent and Trademark Office, but otherwise reserves all copyright rights.

### BACKGROUND OF THE INVENTION

1. Field of the Invention

The present disclosure relates to software, systems, and computer implemented methods to provide comparative analyses and results of criteria of certain big data sets.

2. Background

Performing calculations on data is not new, but the system and methods disclosed herein are unique and offer a more accurate system to predict certain outcomes than what currently exists.

### BRIEF SUMMARY OF THE INVENTION

The system and method disclosed herein provides a ranking and rating system based on a custom algorithm designed to correlate and analyze information or data from diverse data sets. The system disclosed herein is adaptable to providing ranking, rating, or predictive analyses of restaurants, movies, music, TV shows, books, consumer sales, social media, sports outcomes, professional or non-professional services, or any other field of human endeavor.

Thus, a user may use the system to obtain predictive, trending, or ranking results across private or public applications or platforms commonly presented and displayed on a computer network, including the Internet. In one embodiment, an analytic engine predicts the outcome of a sporting event by applying algorithms to a big data set to predict a most likely outcome of an event, such as a tournament, a sports team or player draft, a college ranking, a power ranking, or seasonal outcomes. In sum, the system aggregates, stores, and manipulates big data and presents a user-accessible output and interface. In the context of this disclosure, big data is a data set so large and complex that it is difficult to process using typical database management tools or traditional data processing applications.

The aggregation function receives data from thousands of distinct and pre-defined third-party websites. By way of non-limiting example only, this data may contain (in whole or in part), historical information or data about the event and/or team, current team makeup, human predictions from field experts, and where applicable, team conference information or data. Once the aggregation is complete and the information or data is stored, calculations (algorithms) are applied to determine most likely outcomes. Outcomes are further analyzed against each another to result in a predictive output, which may correlate to a comparative rank of an entity (e.g., a team) or person within a set of competitors or peers.

### DESCRIPTION OF THE DRAWINGS

The invention can be better understood by reference to the following drawings, wherein:

FIG. 1 is a diagram of the system and method disclosed herein.

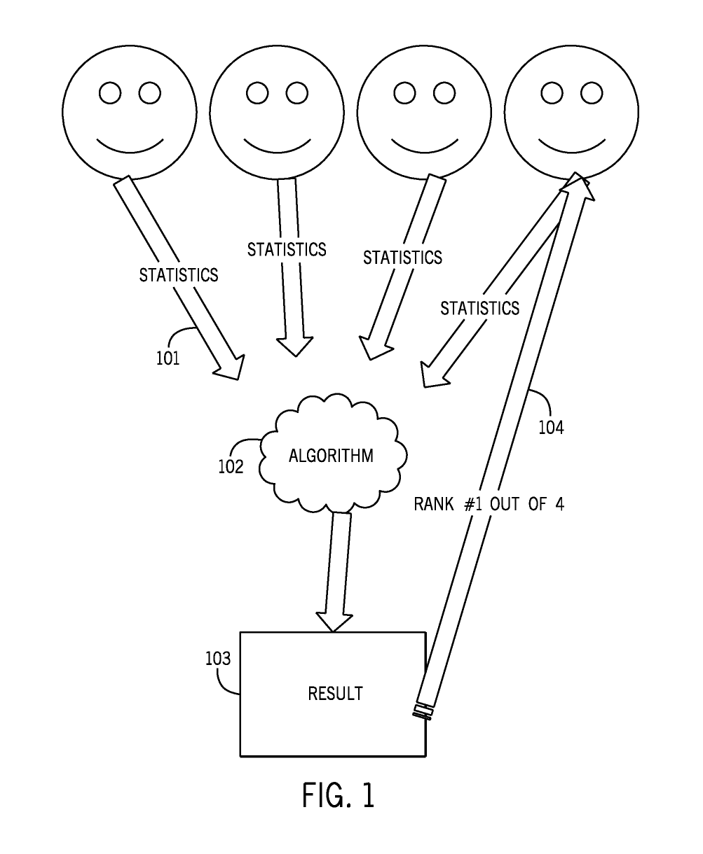

FIG. 2 is a diagram of the data flow of an embodiment of the system and method disclosed herein.

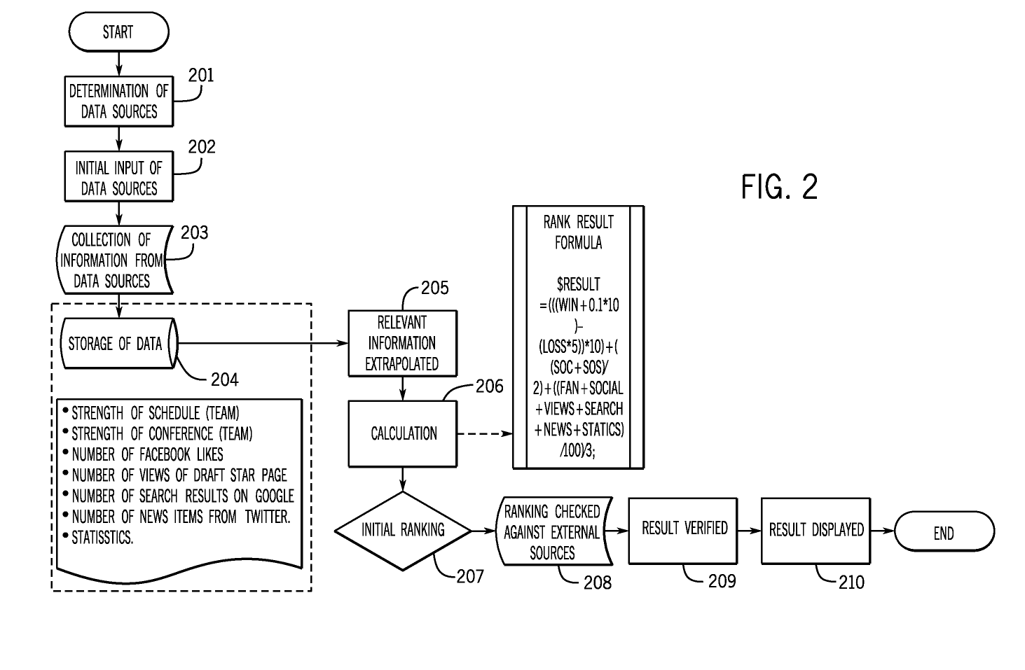

FIG. 3 is a diagram of the data flow of an embodiment of the system and method disclosed herein.

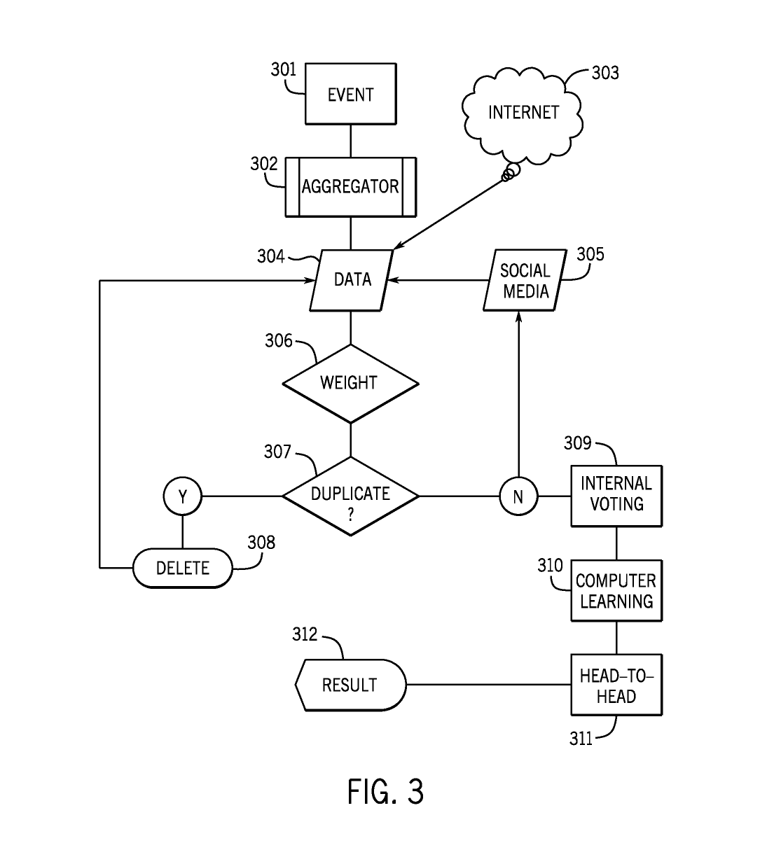

FIG. 4 is a mock web-browser-accessible presentation layer of the system and method disclosed herein.

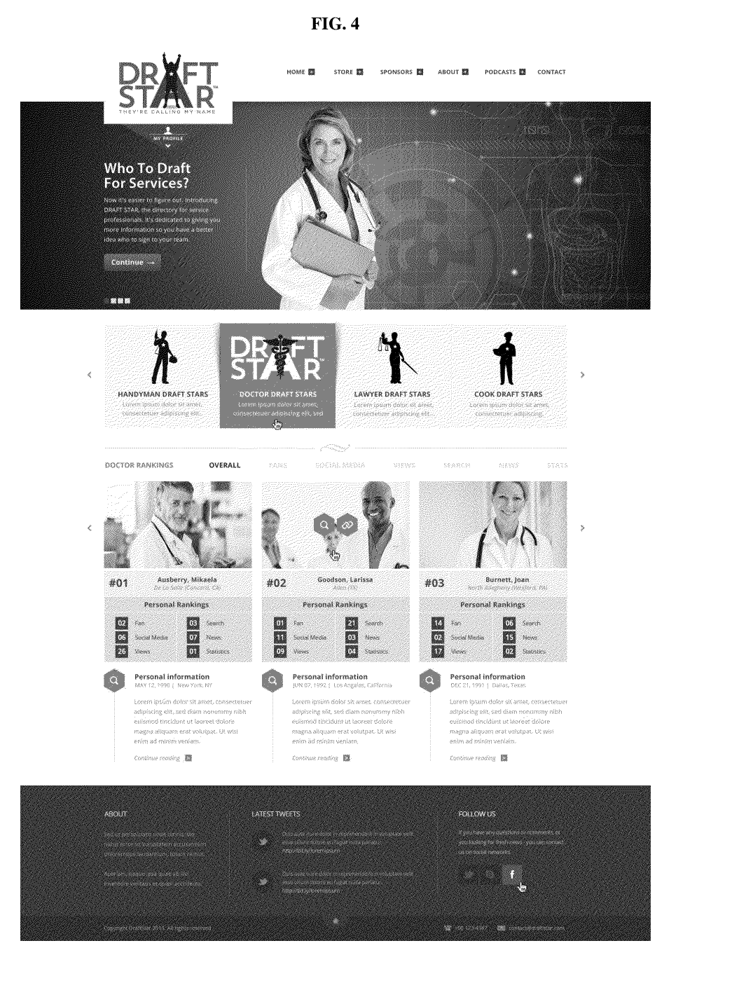

FIG. 5 is a mock web-browser-accessible presentation layer of the system and method disclosed herein.

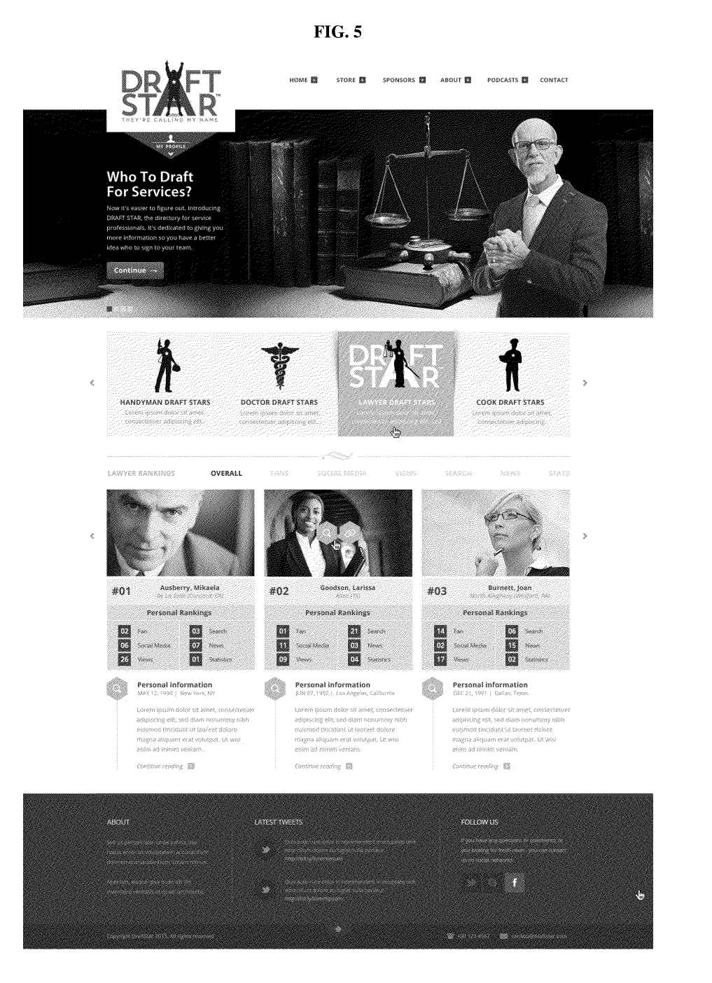

FIG. 6 is a mock web-browser-accessible presentation layer of the system and method disclosed herein.

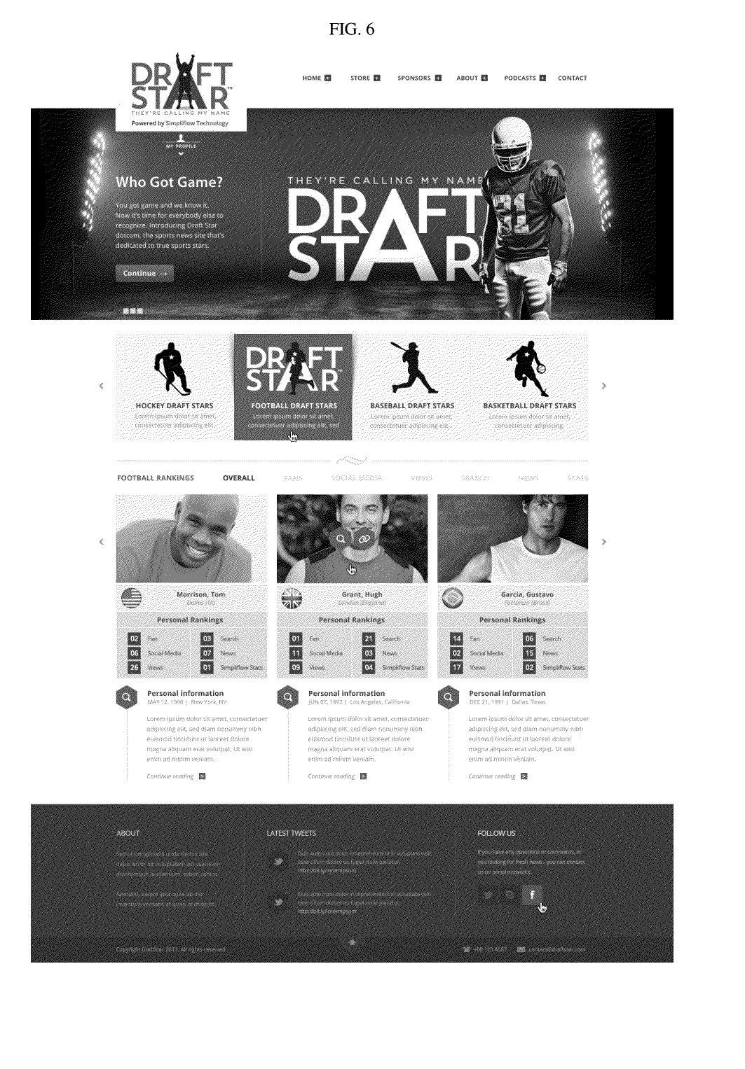

### DETAILED DESCRIPTION

In the following detailed description, reference is made to the accompanying drawings that form a part hereof, and in which are shown by way of illustration specific embodiments or examples. These embodiments may be combined, other embodiments may be utilized, and structural, logical, and procedural changes may be made without departing from the spirit and scope of the present invention. The following detailed description is, therefore, not to be taken in a limiting sense, and the scope of the present invention is defined by the appended claims and their equivalents.

Although the present disclosure relates primarily to a sports-prediction system and associated algorithm, the disclosure is not limited solely to sports. The system is also adaptable to provide ranking, rating, or predictive analyses of restaurants, movies, TV shows, books, music, consumer sales, social media, professional or non-professional services, or any field of human endeavor and is, therefore, suitable for predictive, trending, or ranking outputs and presentation.

By way of non-limiting example only, an embodiment of the system includes a Sports Prediction Algorithm (SPA) that utilizes the following components in order to determine (or predict) a result, including the outcome of a sporting event with better accuracy than current sports prediction tools. The inventors believe the system utilizes a unique, defensible approach to predictive analytics and is the first type of this prediction tool.

A step of the system includes aggregating information or data 101 203 302. Aggregated information or data may be obtained from various sources such as the predictions of sports software, bloggers, analysts, and everyday people in determining the greatest consensus amongst them as to a likely outcome 101 201. In sum, aggregated information includes data collected from multiple incongruent sources 101 and the code shown at DS-MATCH SCRAPER.TXT in the computer program listing appendix discloses means to collect and aggregate information or data from multiple incongruent sources 202 303 like, for example, websites.

Aggregated information or data may be triggered by an event 301, like, for example, a real or fantasy professional sports player draft. Web crawler servers of the type known in the art may be utilized to retrieve information or data from the various sources 202 303. A database of the types well known by those of skill in the art, including a relational database, may be used to store aggregated information or data 204 304. The database shown in DS-DATABASE.PDF in the computer program listing appendix discloses a type of database compatible with the system and method disclosed herein.

The system further allows weighing aggregated information or data based on its validity or the past success rate of the purveyor of the information or data 205 306. The weighing or relevance aspect of the system 205 306 may include likely outcome matching based on computer modeling. Aggregations with more validity are given a higher weight factor than ones with less validity, thus strengthening the model.

The algorithm underlying the SPA is based on a relational database collection and Structured Query Language (SQL), coupled with programmable results displayed under certain script protocols like, for example, PHP or Python. The algorithm provides dynamic results 103 210 312 based on a set of criteria (as listed above), and can be applied across a multitude of platforms and events with no discernible deviation of results. The inventors believe SPA is a set of unique queries on a particular data structure that is nearly impossible to duplicate and is encrypted and secure. These queries are utilized to select the data from various database tables, and organize them for presentation. The uniqueness of these queries is not from the query itself, but how the tables are organized in the database and the presentation layer that performs additional calculations on the data.

By way of non-limiting example only, and as shown in part at 206, a calculation may include, result=(((A+0.1*10)B*5))*10)+((C+D)/2)+((E+F+G+H+I+J)/100)/3, where factors A-J may further include:

A. Team Wins;

B. Team Losses;

C. Strength of Team Schedule; and/or

D. Strength of Team Conference.

Other factors, like E-J, include the number of Facebook fans, YouTube ranking, etc. By way of example only, the code shown in DS-GOOGLE SEARCH.TXT and DS-SEARCH.TXT discloses means to rank a team according to the count of Google or non-Google search results. Taken in whole or in part, the algorithmic analysis of these factors may result in a preliminary result 207.

In the case where multiple outcomes of the same event are determined (such as Sports Drafts), the system includes a de-duplication feature 307 to ensure that two different variables are not presented with the same result (i.e. the same player cannot be picked first and also third.) In this example, once a player is selected, he or she must be removed from the result 308.

A user also may enter team requirements or coaching tendencies into the system 101 309 for algorithmic analysis 102 206. This feature assists the computer-learning or self-learning aspect of the system 310 that allows it to learn and better predict which player or outcome best matches an opponent (in terms of head-to-head matches) or the needs of the team (in terms of drafting players). By way of non-limiting example only, head-to-head matches 311 may include the analysis of thousands of outcome simulations to determine a factor to be applied to a final result 103 210 312. The code shown in DS-BASEBALL FORM.TXT, DS-BASKETBALL FORM.TXT, DS-FOOTBALL FORM.TXT, and DS-HOCKEY FORM.TXT in the computer program listing appendix discloses means to determine the results page for each individual sport and works in tandem with the DS-TEAM PAGE.TXT code.

The system also allows for input of the quality and quantity of social media discussions 305 that serve to add a ‘real-time’ element to any predictive output 104 210 to ensure that any last minute information or data can be incorporated into a final result 103 210 312. The code shown in DS-SOCIAL MEDIA SCRAPER.TXT in the computer program listing appendix discloses means to collect and aggregate code from social media.

The system further provides an internal voting mechanism 309 that allows the system to accept predictions from individual users of the system and incorporate those predictions into a final result 103 210 312, predictive or otherwise. The code shown in DS-SUBMISSION FORM.TXT in the computer program listing appendix discloses means to submit manual information or data. The system in this embodiment may be Internet accessible. The system also includes a computer learning function 310 that allows the system to analyze its past results and make adjustments to future results based on pattern tendencies over time.

In an embodiment of a presentation layer comprising sports statistics, the code shown at DS-TEAM PAGE TEMPLATE.TXT in the computer program listing appendix discloses algorithmic means to calculate 102 206 final comparative or predictive ranking results 103 210 312, and the code shown in DS-SPORTS TEMPLATE.TXT, DS-TEAM PAGE.TXT, and DS-STYLESHEET.TXT in the computer program listing appendix discloses means to present those results for a particular team with a particular web site design or presentation layer.

It is to be understood that the above description is intended to be illustrative and not restrictive. For example, the above-described embodiments and variations may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

The following computer software program constitutes the system and method disclosed herein and is incorporated into this disclosure. The computer software program is fully set forth in the computer program listing appendix, which includes the program files are listed below:
DS-Match Scraper.txt
DS-Search.txt
DS-Social Media Scraper.txt
DS-Sports Template.txt
DS-S tyle sheet.txt
DS-Submission Form.txt
DS-Team Page Template.txt
DS-Team Page.txt
DS-Baseball Form.txt
DS-Basketball Form.txt
DS-Tan Search.txt
DS-Football Form.txt
DS-Google Search.txt
DS-Hockey Form.txt
DS-Database.pdf

Draft Star

| id | team1 | team2 | date | location | t1name |
|---|---|---|---|---|---|
| 133 | 517 | 594 | 14-Sep-2013-03 -45-PM | | Georgia Tech Yellow Jackets |
| 135 | 632 | 621 | 14-Sep-2013-08 -00-AM | | Tennessee Volunteers |
| 132 | 558 | 494 | 14-Sep-2013-07 -30-PM | | Boston College Eagles |
| 129 | 548 | 597 | 14-Sep-2013-03 -30-PM | | Louisiana-Monroe Warhawks |
| 130 | 564 | 584 | 14-Sep-2013-09 -00-PM | | Eastern Michigan Eagles |
| 128 | 586 | 624 | 14-Sep-2013-06 -30-PM | | New Mexico Lobos |
| 127 | 576 | 481 | 14-Sep-2013-08 -30-AM | | Southern Miss Golden Eagles |
| 126 | 515 | 666 | 14-Sep-2013-09 -45-AM | | Georgia State Panthers |
| 125 | 619 | 614 | 14-Sep-2013-06 -30-PM | | Tulsa Golden Hurricane |
| 124 | 492 | 580 | 14-Sep-2013-02 -00-PM | | UCLA Bruins |
| 123 | 600 | 566 | 14-Sep-2013-10 -00-AM | | Akron Zips |
| 122 | 542 | 541 | 14-Sep-2013-07 -30-PM | | Louisville Cardinals |
| 121 | 602 | 527 | 14-Sep-2013-03 -15-PM | | Bowling Green Falcons |
| 120 | 662 | 595 | 14-Sep-2013-05 -30-PM | | Virginia Tech Hokies |
| 119 | 491 | 589 | 14-Sep-2013-05 -15-PM | | Stanford Cardinal |
| 118 | 495 | 520 | 13-Sep-2013-05 -30-PM | | Air Force Falcons |
| 117 | 645 | 652 | 12-Sep-2013-05 -00-PM | | TCU Horned Frogs |
| 116 | 554 | 550 | 12-Sep-2013-02 -30-PM | | Tulane Green Wave |
| 115 | 473 | 482 | 12-Sep-2013-03 -05-PM | | Troy Trojans |
| 131 | 485 | 497 | 14-Sep-2013-01 -00-PM | | Fresno State Bulldogs |
| 134 | 581 | 507 | 14-Sep-2013-12 -00-PM | | Nevada Wolf Pack |
| 76 | 512 | 501 | 06-Sep-2013-01 -00-PM | | UCF Knights |
| 75 | 507 | 624 | 02-Sep-2013-01 -00-AM | | Florida State Seminoles |
| 136 | 452 | 649 | 14-Sep-2013-05 -30-PM | | Alabama Crimson Tide |
| 137 | 525 | 638 | 14-Sep-2013-02 -15-PM | | Ball State Cardinals |
| 341 | 505 | 595 | 03-Mar-2014-01 -00-AM | testwebx | Florida Atlantic Owls |
| 342 | 610 | 542 | 01-Sep-2013-01 -00-PM | | Ohio Bobcats |
| 140 | 669 | 521 | 14-Sep-2013-09 -15-AM | | NIU Huskies |
| 141 | 662 | 452 | 01-Jan-2014-01 -00-AM | | Virginia Tech Hokies |
| 142 | 663 | 522 | 14-Sep-2013-03 -30-PM | | Washington Huskies |
| 143 | 533 | 535 | 14-Sep-2013-11 -30-AM | | Iowa Hawkeyes |
| 144 | 512 | 623 | 14-Sep-2013-11 -30-AM | | UCF Knights |
| 145 | 574 | 455 | 14-Sep-2013-12 -15-PM | | Mississippi State Bulldogs |
| 146 | 611 | 484 | 14-Sep-2013-10 -00-AM | | Ohio State Buckeyes |
| 147 | 606 | 552 | 14-Sep-2013-09 -00-AM | | Kent State Golden Flashes |
| 148 | 628 | 629 | 14-Sep-2013-11 -45-AM | | Memphis Tigers |
| 149 | 633 | 627 | 14-Sep-2013-11 -00-AM | | Vanderbilt Commodores |
| 150 | 505 | 510 | 14-Sep-2013-05 -30-PM | | Florida Atlantic Owls |
| 151 | 556 | 499 | 14-Sep-2013-03 -15-PM | | Maryland Terrapins |
| 152 | 537 | 642 | 14-Sep-2013-04 -30-PM | | Kansas Jayhawks |
| 153 | 544 | 471 | 14-Sep-2013-01 -00-PM | | Western Kentucky Hilltoppers |
| 154 | 653 | 588 | 14-Sep-2013-11 -45-AM | | UTEP Miners |
| 155 | 665 | 610 | 14-Sep-2013-06 -30-PM | | Marshall Thundering Herd |
| 156 | 529 | 531 | 14-Sep-2013-10 -15-AM | | Notre Dame Fighting Irish |
| 157 | 575 | 647 | 14-Sep-2013-11 -30-AM | | Ole Miss Rebels |
| 158 | 570 | 524 | 14-Sep-2013-05 -45-PM | | Western Michigan Broncos |
| 159 | 562 | 583 | 14-Sep-2013-01 -30-PM | | Central Michigan Chippewas |
| 160 | 622 | 658 | 14-Sep-2013-02 -10-PM | | Oregon State Beavers |
| 161 | 667 | 479 | 14-Sep-2013-09 -30-AM | | Wisconsin Badgers |
| 162 | 626 | 671 | 19-Sep-2013-01 -00-PM | | Clemson Tigers |
| 163 | 520 | 485 | 20-Sep-2013-01 -00-PM | | Boise State Broncos |
| 164 | 597 | 589 | 21-Sep-2013-01 -00-PM | | Wake Forest Demon Deacons |
| 165 | 612 | 562 | 21-Sep-2013-01 -00-PM | | Toledo Rockets |
| 166 | 629 | 505 | 21-Sep-2013-01 -00-PM | | Middle Tennessee Blue Raiders |
| 167 | 525 | 564 | 21-Sep-2013-01 -00-PM | | Ball State Cardinals |
| 168 | 635 | 642 | 21-Sep-2013-01 -00-PM | | Houston Cougars |
| 169 | 632 | 503 | 21-Sep-2013-01 -00-PM | | Tennessee Volunteers |
| 170 | 568 | 529 | 21-Sep-2013-01 -00-PM | | Michigan State Spartans |
| 171 | 546 | 600 | 21-Sep-2013-01 -00-PM | | Louisiana-Lafayette Ragin Cajuns |
| 172 | 650 | 652 | 21-Sep-2013-01 -00-PM | | Texas State Bobcats |
| 173 | 622 | 487 | 21-Sep-2013-01 -00-PM | | Oregon State Beavers |
| 174 | 578 | 527 | 21-Sep-2013-01 -00-PM | | Missouri Tigers |
| 175 | 662 | 517 | 26-Sep-2013-01 -00-PM | | Virginia Tech Hokies |
| 176 | 535 | 619 | 26-Sep-2013-01 -00-PM | | Iowa State Cyclones |
| 177 | 629 | 657 | 27-Sep-2013-01 -00-PM | | Middle Tennessee Blue Raiders |
| 178 | 659 | 489 | 27-Sep-2013-01 -00-PM | | Utah State Aggies |
| 179 | 612 | 525 | 28-Sep-2013-01 -00-PM | | Toledo Rockets |
| 180 | 499 | 591 | 28-Sep-2013-01 -00-PM | | Connecticut Huskies |
| 181 | 653 | 498 | 28-Sep-2013-01 -00-PM | | UTEP Miners |
| 182 | 589 | 550 | 28-Sep-2013-01 -00-PM | | Army Black Knights |
| 183 | 533 | 572 | 28-Sep-2013-01 -00-PM | | Iowa Hawkeyes |
| 184 | 614 | 529 | 28-Sep-2013-01 -00-PM | | Oklahoma Sooners |
| 185 | 625 | 521 | 28-Sep-2013-01 -00-PM | | Temple Owls |
| 186 | 554 | 548 | 28-Sep-2013-01 -00-PM | | Tulane Green Wave |
| 187 | 505 | 642 | 28-Sep-2013-01 -00-PM | | Florida Atlantic Owls |
| 188 | 668 | 650 | 28-Sep-2013-01 -00-PM | | Wyoming Cowboys |
| 189 | 557 | 544 | 28-Sep-2013-01 -00-PM | | Navy Midshipmen |
| 190 | 606 | 570 | 28-Sep-2013-01 -00-PM | | Kent State Golden Flashes |
| 191 | 495 | 581 | 28-Sep-2013-01 -00-PM | | Air Force Falcons |
| 192 | 583 | 586 | 28-Sep-2013-01 -00-PM | | UNLV Rebels |
| 193 | 487 | 588 | 28-Sep-2013-01 -00-PM | | San Diego State Aztecs |
| 194 | 667 | 611 | 28-Sep-2013-01 -00-PM | | Wisconsin Badgers |
| 195 | 647 | 535 | 03-Oct-2013-01 -00-PM | | Texas Longhorns |
| 196 | 544 | 548 | 03-Oct-2013-01 -00-PM | | Western Kentucky Hilltoppers |
| 197 | 492 | 658 | 03-Oct-2013-01 -00-PM | | UCLA Bruins |
| 198 | 657 | 659 | 04-Oct-2013-01 -00-PM | | BYU Cougars |
| 199 | 581 | 487 | 04-Oct-2013-01 -00-PM | | Nevada Wolf Pack |
| 200 | 495 | 557 | 05-Oct-2013-01 -00-PM | | Air Force Falcons |
| 201 | 564 | 591 | 05-Oct-2013-01 -00-PM | | Eastern Michigan Eagles |
| 202 | 568 | 533 | 05-Oct-2013-01 -00-PM | | Michigan State Spartans |
| 203 | 522 | 580 | 05-Oct-2013-01 -00-PM | | Illinois Fighting Illini |
| 204 | 471 | 473 | 05-Oct-2013-01 -00-PM | | South Alabama Jaguars |
| 205 | 610 | 600 | 05-Oct-2013-01 -00-PM | | Ohio Bobcats |
| 206 | 588 | 586 | 05-Oct-2013-01 -00-PM | | New Mexico State Aggies |
| 207 | 570 | 612 | 05-Oct-2013-01 -00-PM | | Western Michigan Broncos |
| 208 | 572 | 566 | 05-Oct-2013-01 -00-PM | | Minnesota Golden Gophers |
| 209 | 638 | 554 | 05-Oct-2013-01 -00-PM | | North Texas Mean Green |
| 210 | 642 | 619 | 05-Oct-2013-01 -00-PM | | Rice Owls |
| 211 | 501 | 576 | 05-Oct-2013-01 -00-PM | | FIU Golden Panthers |
| 212 | 485 | 521 | 05-Oct-2013-01 -00-PM | | Fresno State Bulldogs |
| 213 | 650 | 546 | 05-Oct-2013-01 -00-PM | | Texas State Bobcats |
| 214 | 529 | 479 | 05-Oct-2013-01 -00-PM | | Notre Dame Fighting Irish |
| 215 | 550 | 653 | 05-Oct-2013-01 -00-PM | | Louisiana Tech Bulldogs |
| 216 | 611 | 524 | 05-Oct-2013-01 -00-PM | | Ohio State Buckeyes |
| 217 | 487 | 495 | 10-Oct-2013-01 -00-PM | | San Diego State Aztecs |
| 218 | 478 | 494 | 10-Oct-2013-01 -00-PM | | Arizona Wildcats |
| 219 | 564 | 589 | 12-Oct-2013-01 -00-PM | | Eastern Michigan Eagles |
| 220 | 527 | 568 | 12-Oct-2013-01 -00-PM | | Indiana Hoosiers |
| 221 | 473 | 515 | 12-Oct-2013-01 -00-PM | | Troy Trojans |
| 222 | 562 | 610 | 12-Oct-2013-01 -00-PM | | Central Michigan Chippewas |
| 223 | 591 | 570 | 12-Oct-2013-01 -00-PM | | Buffalo Bulls |
| 224 | 606 | 525 | 12-Oct-2013-01 -00-PM | | Kent State Golden Flashes |
| 225 | 489 | 498 | 12-Oct-2013-01 -00-PM | | San Jose State Spartans |
| 226 | 595 | 554 | 12-Oct-2013-01 -00-PM | | East Carolina Pirates |
| 227 | 524 | 667 | 12-Oct-2013-01 -00-PM | | Northwestern Wildcats |
| 228 | 586 | 668 | 12-Oct-2013-01 -00-PM | | New Mexico Lobos |
| 233 | 520 | 659 | 12-Oct-2013-01 -00-PM | | Boise State Broncos |
| 229 | 665 | 505 | 12-Oct-2013-01 -00-PM | | Marshall Thundering Herd |
| 230 | 566 | 623 | 12-Oct-2013-01 -00-PM | | Michigan Wolverines |
| 231 | 629 | 638 | 12-Oct-2013-01 -00-PM | | Middle Tennessee Blue Raiders |
| 232 | 548 | 650 | 12-Oct-2013-01 -00-PM | | Louisiana-Monroe Warhawks |
| 234 | 546 | 544 | 15-Oct-2013-01 -00-PM | | Louisiana-Lafayette Ragin Cajuns |
| 235 | 610 | 564 | 19-Oct-2013-01 -00-PM | | Ohio Bobcats |
| 236 | 659 | 586 | 19-Oct-2013-01 -00-PM | | Utah State Aggies |
| 237 | 525 | 570 | 19-Oct-2013-01 -00-PM | | Ball State Cardinals |
| 238 | 498 | 668 | 19-Oct-2013-01 -00-PM | | Colorado State Rams |
| 239 | 527 | 566 | 19-Oct-2013-01 -00-PM | | Indiana Hoosiers |
| 240 | 533 | 611 | 19-Oct-2013-01 -00-PM | | Iowa Hawkeyes |
| 241 | 638 | 550 | 19-Oct-2013-01 -00-PM | | North Texas Mean Green |
| 242 | 515 | 650 | 19-Oct-2013-01 -00-PM | | Georgia State Panthers |
| 243 | 557 | 612 | 19-Oct-2013-01 -00-PM | | Navy Midshipmen |
| 244 | 494 | 529 | 19-Oct-2013-01 -00-PM | | USC Trojans |
| 245 | 581 | 520 | 19-Oct-2013-01 -00-PM | | Nevada Wolf Pack |
| 246 | 667 | 522 | 19-Oct-2013-01 -00-PM | | Wisconsin Badgers |
| 247 | 642 | 588 | 19-Oct-2013-01 -00-PM | | Rice Owls |
| 263 | 471 | 650 | 26-Oct-2013-01 -00-PM | | South Alabama Jaguars |
| 248 | 583 | 485 | 19-Oct-2013-01 -00-PM | | UNLV Rebels |
| 249 | 546 | 482 | 21-Oct-2013-01 -00-PM | | Louisiana-Lafayette Ragin Cajuns |
| 250 | 665 | 629 | 24-Oct-2013-01 -00-PM | | Marshall Thundering Herd |
| 251 | 541 | 574 | 24-Oct-2013-01 -00-PM | | Kentucky Wildcats |
| 252 | 520 | 657 | 25-Oct-2013-01 -00-PM | | Boise State Broncos |
| 253 | 525 | 600 | 26-Oct-2013-01 -00-PM | | Ball State Cardinals |
| 254 | 624 | 557 | 26-Oct-2013-01 -00-PM | | Pittsburgh Panthers |
| 255 | 608 | 610 | 26-Oct-2013-01 -00-PM | | Miami RedHawks |
| 256 | 568 | 522 | 26-Oct-2013-01 -00-PM | | Michigan State Spartans |
| 257 | 619 | 554 | 26-Oct-2013-01 -00-PM | | Tulsa Golden Hurricane |
| 258 | 473 | 544 | 26-Oct-2013-01 -00-PM | | Troy Trojans |
| 259 | 529 | 495 | 26-Oct-2013-01 -00-PM | | Notre Dame Fighting Irish |
| 260 | 515 | 548 | 26-Oct-2013-01 -00-PM | | Georgia State Panthers |
| 261 | 668 | 489 | 26-Oct-2013-01 -00-PM | | Wyoming Cowboys |
| 262 | 638 | 576 | 26-Oct-2013-01 -00-PM | | North Texas Mean Green |
| 264 | 623 | 611 | 26-Oct-2013-01 -00-PM | | Penn State Nittany Lions |
| 265 | 642 | 638 | 31-Oct-2013-01 -00-PM | | Rice Owls |
| 266 | 548 | 473 | 31-Oct-2013-01 -00-PM | | Louisiana-Monroe Warhawks |
| 267 | 479 | 664 | 31-Oct-2013-01 -00-PM | | Arizona State Sun Devils |
| 268 | 494 | 622 | 01-Nov-2013-01 -00-PM | | USC Trojans |
| 269 | 576 | 665 | 02-Nov-2013-01 -00-PM | | Southern Miss Golden Eagles |
| 270 | 629 | 475 | 02-Nov-2013-01 -00-PM | | Middle Tennessee Blue Raiders |
| 271 | 544 | 515 | 02-Nov-2013-01 -00-PM | | Western Kentucky Hilltoppers |
| 272 | 606 | 600 | 02-Nov-2013-01 -00-PM | | Kent State Golden Flashes |
| 273 | 503 | 514 | 02-Nov-2013-01 -00-PM | | Florida Gators |
| 274 | 572 | 527 | 02-Nov-2013-01 -00-PM | | Minnesota Golden Gophers |
| 275 | 557 | 529 | 02-Nov-2013-01 -00-PM | | Navy Midshipmen |
| 276 | 489 | 583 | 02-Nov-2013-01 -00-PM | | San Jose State Spartans |
| 277 | 650 | 521 | 02-Nov-2013-01 -00-PM | | Texas State Bobcats |
| 278 | 588 | 546 | 02-Nov-2013-01 -00-PM | | New Mexico State Aggies |
| 279 | 581 | 485 | 02-Nov-2013-01 -00-PM | | Nevada Wolf Pack |
| 280 | 564 | 612 | 02-Nov-2013-01 -00-PM | | Eastern Michigan Eagles |
| 281 | 520 | 498 | 02-Nov-2013-01 -00-PM | | Boise State Broncos |
| 282 | 610 | 591 | 05-Nov-2013-01 -00-PM | | Ohio Bobcats |
| 283 | 602 | 608 | 05-Nov-2013-01 -00-PM | | Bowling Green Falcons |
| 284 | 562 | 525 | 06-Nov-2013-01 -00-PM | | Central Michigan Chippewas |
| 285 | 614 | 634 | 07-Nov-2013-01 -00-PM | | Oklahoma Sooners |
| 286 | 473 | 546 | 07-Nov-2013-01 -00-PM | | Troy Trojans |
| 287 | 621 | 491 | 07-Nov-2013-01 -00-PM | | Oregon Ducks |
| 288 | 495 | 586 | 08-Nov-2013-01 -00-PM | | Air Force Falcons |
| 289 | 544 | 589 | 09-Nov-2013-01 -00-PM | | Western Kentucky Hilltoppers |
| 290 | 475 | 665 | 09-Nov-2013-01 -00-PM | | UAB Blazers |
| 291 | 570 | 564 | 09-Nov-2013-01 -00-PM | | Western Michigan Broncos |
| 292 | 485 | 668 | 09-Nov-2013-01 -00-PM | | Fresno State Bulldogs |
| 293 | 653 | 638 | 09-Nov-2013-01 -00-PM | | UTEP Miners |
| 294 | 501 | 629 | 09-Nov-2013-01 -00-PM | | FIU Golden Panthers |
| 295 | 576 | 550 | 09-Nov-2013-01 -00-PM | | Southern Miss Golden Eagles |
| 296 | 482 | 548 | 09-Nov-2013-01 -00-PM | | Arkansas State Red Wolves |
| 297 | 552 | 452 | 09-Nov-2013-01 -00-PM | | LSU Tigers |
| 298 | 487 | 489 | 09-Nov-2013-01 -00-PM | | San Diego State Aztecs |
| 299 | 610 | 602 | 12-Nov-2013-01 -00-PM | | Ohio Bobcats |
| 300 | 591 | 612 | 12-Nov-2013-01 -00-PM | | Buffalo Bulls |
| 301 | 608 | 606 | 13-Nov-2013-01 -00-PM | | Miami RedHawks |
| 302 | 517 | 626 | 14-Nov-2013-01 -00-PM | | Georgia Tech Yellow Jackets |
| 303 | 665 | 619 | 14-Nov-2013-01 -00-PM | | Marshall Thundering Herd |
| 304 | 663 | 492 | 15-Nov-2013-01 -00-PM | | Washington Huskies |
| 305 | 562 | 570 | 16-Nov-2013-01 -00-PM | | Central Michigan Chippewas |
| 306 | 505 | 576 | 16-Nov-2013-01 -00-PM | | Florida Atlantic Owls |
| 307 | 546 | 515 | 16-Nov-2013-01 -00-PM | | Louisiana-Lafayette Ragin Cajuns |
| 308 | 498 | 586 | 16-Nov-2013-01 -00-PM | | Colorado State Rams |
| 309 | 471 | 557 | 16-Nov-2013-01 -00-PM | | South Alabama Jaguars |
| 310 | 550 | 642 | 16-Nov-2013-01 -00-PM | | Louisiana Tech Bulldogs |
| 311 | 591 | 608 | 19-Nov-2013-01 -00-PM | | Buffalo Bulls |
| 312 | 606 | 610 | 19-Nov-2013-01 -00-PM | | Kent State Golden Flashes |
| 313 | 642 | 475 | 21-Nov-2013-01 -00-PM | | Rice Owls |
| 314 | 583 | 495 | 21-Nov-2013-01 -00-PM | | UNLV Rebels |
| 343 | 497 | 498 | 01-Sep-2013-01 -00-PM | | Colorado Buffaloes |
| 315 | 557 | 489 | 22-Nov-2013-01 -00-PM | | Navy Midshipmen |
| 316 | 602 | 564 | 23-Nov-2013-01 -00-PM | | Bowling Green Falcons |
| 323 | 619 | 550 | 23-Nov-2013-01 -00-PM | | Tulsa Golden Hurricane |
| 317 | 649 | 552 | 23-Nov-2013-01 -00-PM | | Texas A&M Aggies |
| 318 | 657 | 529 | 23-Nov-2013-01 -00-PM | | BYU Cougars |
| 319 | 629 | 576 | 23-Nov-2013-01 -00-PM | | Middle Tennessee Blue Raiders |
| 320 | 653 | 554 | 23-Nov-2013-01 -00-PM | | UTEP Miners |
| 321 | 498 | 659 | 23-Nov-2013-01 -00-PM | | Colorado State Rams |
| 322 | 586 | 485 | 23-Nov-2013-01 -00-PM | | New Mexico Lobos |
| 324 | 520 | 487 | 23-Nov-2013-01 -00-PM | | Boise State Broncos |
| 325 | 575 | 574 | 28-Nov-2013-01 -00-PM | | Ole Miss Rebels |
| 326 | 652 | 647 | 28-Nov-2013-01 -00-PM | | Texas Tech Red Raiders |
| 327 | 595 | 665 | 29-Nov-2013-01 -00-PM | | East Carolina Pirates |
| 328 | 533 | 580 | 29-Nov-2013-01 -00-PM | | Iowa Hawkeyes |
| 329 | 481 | 552 | 29-Nov-2013-01 -00-PM | | Arkansas Razorbacks |
| 330 | 501 | 505 | 29-Nov-2013-01 -00-PM | | FIU Golden Panthers |
| 331 | 485 | 489 | 29-Nov-2013-01 -00-PM | | Fresno State Bulldogs |
| 332 | 664 | 663 | 29-Nov-2013-01 -00-PM | | Washington State Cougars |
| 333 | 622 | 621 | 29-Nov-2013-01 -00-PM | | Oregon State Beavers |
| 334 | 576 | 475 | 30-Nov-2013-01 -00-PM | | Southern Miss Golden Eagles |
| 335 | 471 | 515 | 30-Nov-2013-01 -00-PM | | South Alabama Jaguars |
| 336 | 668 | 659 | 30-Nov-2013-01 -00-PM | | Wyoming Cowboys |
| 337 | 657 | 581 | 30-Nov-2013-01 -00-PM | | BYU Cougars |
| 338 | 554 | 642 | 30-Nov-2013-01 -00-PM | | Tulane Green Wave |
| 339 | 482 | 544 | 30-Nov-2013-01 -00-PM | | Arkansas State Red Wolves |
| 340 | 548 | 546 | 30-Nov-2013-01 -00-PM | | Louisiana-Monroe Warhawks |
| 348 | 452 | 662 | 31-Aug-2013-01 -00-PM | | Alabama Crimson Tide |
| 345 | 505 | 595 | 05-Sep-2013-01 -00-PM | | Florida Atlantic Owls |
| 346 | 597 | 558 | 06-Sep-2013-01 -00-PM | | Wake Forest Demon Deacons |
| 347 | 512 | 501 | 06-Sep-2013-01 -00-PM | | UCF Knights |
| 349 | 591 | 611 | 31-Aug-2013-01 -00-AM | | Buffalo Bulls |
| 350 | 514 | 626 | 31-Aug-2013-01 -00-AM | | Georgia Bulldogs |
| 351 | 642 | 649 | 01-Jan-2013-01 -00-AM | | Rice Owls |
| 352 | 642 | 649 | 31-Aug-2013-01 -00-PM | | Rice Owls |
| 353 | 612 | 503 | 31-Aug-2013-01 -00-PM | | Toledo Rockets |
| 354 | 552 | 645 | 31-Aug-2013-01 -00-PM | | LSU Tigers |
| 355 | 574 | 615 | 31-Aug-2013-01 -00-PM | | Mississippi State Bulldogs |
| 356 | 625 | 529 | 31-Aug-2013-01 -00-AM | | Temple Owls |
| 357 | 588 | 647 | 31-Aug-2013-01 -00-PM | | New Mexico State Aggies |
| 358 | 548 | 614 | 31-Aug-2013-01 -00-PM | | Louisiana-Monroe Warhawks |
| 359 | 562 | 566 | 31-Aug-2013-01 -00-PM | | Central Michigan Chippewas |
| 360 | 668 | 580 | 31-Aug-2013-01 -00-PM | | Wyoming Cowboys |
| 361 | 520 | 663 | 31-Aug-2013-01 -00-AM | | Boise State Broncos |
| 362 | 581 | 492 | 31-Aug-2013-01 -00-AM | | Nevada Wolf Pack |
| 363 | 524 | 484 | 31-Aug-2013-01 -00-AM | | Northwestern Wildcats |
| 364 | 560 | 667 | 31-Aug-2013-01 -00-PM | | UMass Minutemen |
| 365 | 564 | 622 | 31-Aug-2013-01 -00-PM | | Eastern Michigan Eagles |
| 366 | 531 | 604 | 31-Aug-2013-01 -00-PM | | Purdue Boilermakers |
| 367 | 501 | 556 | 31-Aug-2013-01 -00-PM | | FIU Golden Panthers |
| 368 | 550 | 671 | 31-Aug-2013-01 -00-PM | | Louisiana Tech Bulldogs |
| 369 | 669 | 533 | 31-Aug-2013-01 -00-PM | | NIU Huskies |
| 370 | 623 | 467 | 31-Aug-2013-01 -00-PM | | Penn State Nittany Lions |
| 371 | 657 | 661 | 31-Aug-2013-01 -00-AM | | BYU Cougars |
| 372 | 546 | 481 | 31-Aug-2013-01 -00-PM | | Louisiana-Lafayette Ragin Cajuns |
| 373 | 664 | 455 | 31-Aug-2013-01 -00-PM | | Washington State Cougars |
| 374 | 541 | 544 | 31-Aug-2013-01 -00-AM | | Kentucky Wildcats |
| 375 | 608 | 665 | 31-Aug-2013-01 -00-PM | | Miami RedHawks |
| 376 | 521 | 638 | 31-Aug-2013-01 -00-PM | | Idaho Vandals |
| 377 | 475 | 473 | 31-Aug-2013-01 -00-AM | | UAB Blazers |
| 378 | 650 | 576 | 31-Aug-2013-01 -00-AM | | Texas State Bobcats |
| 379 | 655 | 586 | 31-Aug-2013-01 -00-PM | | UTSA Roadrunners |
| 380 | 621 | 661 | 07-Sep-2013-01 -00-PM | | Oregon Ducks |
| 381 | 487 | 611 | 07-Sep-2013-01 -00-AM | | San Diego State Aztecs |
| 383 | 489 | 491 | 07-Sep-2013-01 -00-PM | | San Jose State Spartans |
| 384 | 627 | 514 | 07-Sep-2013-01 -00-PM | | South Carolina Gamecocks |
| 385 | 475 | 552 | 07-Sep-2013-01 -00-PM | | UAB Blazers |
| 386 | 503 | 508 | 07-Sep-2013-01 -00-AM | | Florida Gators |
| 387 | 615 | 655 | 07-Sep-2013-01 -00-AM | | Oklahoma State Cowboys |
| 388 | 529 | 566 | 07-Sep-2013-01 -00-PM | | Notre Dame Fighting Irish |
| 389 | 647 | 657 | 07-Sep-2013-01 -00-PM | | Texas Longhorns |
| 390 | 666 | 614 | 07-Sep-2013-01 -00-PM | | West Virginia Mountaineers |
| 391 | 467 | 524 | 07-Sep-2013-01 -00-PM | | Syracuse Orange |
| 392 | 576 | 580 | 07-Sep-2013-01 -00-PM | | Southern Miss Golden Eagles |
| 393 | 591 | 634 | 07-Sep-2013-01 -00-PM | | Buffalo Bulls |
| 394 | 664 | 494 | 07-Sep-2013-01 -00-PM | | Washington State Cougars |
| 395 | 602 | 606 | 07-Sep-2013-01 -00-PM | | Bowling Green Falcons |
| 396 | 608 | 541 | 07-Sep-2013-01 -00-AM | | Miami RedHawks |
| 397 | 510 | 568 | 07-Sep-2013-01 -00-PM | | South Florida Bulls |
| 398 | 564 | 623 | 07-Sep-2013-01 -00-AM | | Eastern Michigan Eagles |
| 399 | 635 | 625 | 07-Sep-2013-01 -00-AM | | Houston Cougars |
| 400 | 604 | 522 | 07-Sep-2013-01 -00-PM | | Cincinnati Bearcats |
| 401 | 544 | 632 | 07-Sep-2013-01 -00-PM | | Western Kentucky Hilltoppers |
| 402 | 629 | 596 | 07-Sep-2013-01 -00-PM | | Middle Tennessee Blue Raiders |
| 403 | 589 | 525 | 07-Sep-2013-01 -00-PM | | Army Black Knights |
| 404 | 471 | 554 | 07-Sep-2013-01 -00-PM | | South Alabama Jaguars |
| 405 | 612 | 578 | 07-Sep-2013-01 -00-PM | | Toledo Rockets |
| 406 | 658 | 495 | 07-Sep-2013-01 -00-PM | | Utah Utes |
| 407 | 521 | 668 | 07-Sep-2013-01 -00-PM | | Idaho Vandals |
| 408 | 594 | 628 | 07-Sep-2013-01 -00-AM | | Duke Blue Devils |
| 409 | 557 | 527 | 07-Sep-2013-01 -00-PM | | Navy Midshipmen |
| 410 | 546 | 539 | 07-Sep-2013-01 -00-PM | | Louisiana-Lafayette Ragin Cajuns |
| 411 | 638 | 610 | 07-Sep-2013-01 -00-PM | | North Texas Mean Green |
| 412 | 498 | 619 | 07-Sep-2013-01 -00-PM | | Colorado State Rams |
| 413 | 482 | 455 | 07-Sep-2013-01 -00-AM | | Arkansas State Red Wolves |
| 414 | 572 | 588 | 07-Sep-2013-01 -00-PM | | Minnesota Golden Gophers |
| 415 | 519 | 622 | 07-Sep-2013-01 -00-AM | | Hawai'i Warriors |
| 416 | 586 | 653 | 07-Sep-2013-01 -00-PM | | New Mexico Lobos |
| 417 | 478 | 583 | 07-Sep-2013-01 -00-AM | | Arizona Wildcats |
| 419 | 655 | 478 | 14-Sep-2013-05-00-PM | | UTSA Roadrunners |

| id | t2name | dd | t1score | t2score | dateds |
|---|---|---|---|---|---|
| 133 | Duke Blue Devils | | 38 | 14 | 2013-09-14 00:00:00 |
| 135 | Oregon Ducks | | 14 | 59 | 2013-09-14 00:00:00 |
| 132 | USC Trojans | | 7 | 35 | 2013-09-14 00:00:00 |
| 129 | Wake Forest Demon Deacons | | 21 | 19 | 2013-09-14 00:00:00 |
| 130 | Rutgers Scarlet Knights | | 10 | 28 | 2013-09-14 00:00:00 |
| 128 | Pittsburgh Panthers | | 27 | 49 | 2013-09-14 00:00:00 |
| 127 | Arkansas Razorbacks | | 3 | 24 | 2013-09-14 00:00:00 |
| 126 | West Virginia Mountaineers | | 7 | 41 | 2013-09-14 00:00:00 |
| 125 | Oklahoma Sooners | | 20 | 51 | 2013-09-14 00:00:00 |
| 124 | Nebraska Cornhuskers | | 41 | 21 | 2013-09-14 00:00:00 |
| 123 | Michigan Wolverines | | 24 | 28 | 2013-09-14 00:00:00 |
| 122 | Kentucky Wildcats | | 27 | 13 | 2013-09-14 00:00:00 |
| 121 | Indiana Hoosiers | | 10 | 42 | 2013-09-14 00:00:00 |
| 120 | East Carolina Pirates | | 15 | 10 | 2013-09-14 00:00:00 |
| 119 | Army Black Knights | | 34 | 20 | 2013-09-14 00:00:00 |
| 118 | Boise State Broncos | | 20 | 42 | 2013-09-13 00:00:00 |
| 117 | Texas Tech Red Raiders | | 10 | 20 | 2013-09-12 00:00:00 |
| 116 | Louisiana Tech Bulldogs | | 24 | 15 | 2013-09-12 00:00:00 |
| 115 | Arkansas State Red Wolves | | 41 | 34 | 2013-09-12 00:00:00 |
| 131 | Colorado Buffaloes | | 0 | 0 | 2013-09-14 00:00:00 |
| 134 | Florida State Seminoles | | 7 | 62 | 2013-09-14 00:00:00 |
| 76 | FIU Golden Panthers | | 0 | 0 | 2013-09-06 00:00:00 |
| 75 | Pittsburgh Panthers | | 41 | 13 | 2013-09-02 00:00:00 |
| 136 | Texas A&M Aggies | | 49 | 42 | 2013-09-14 00:00:00 |
| 137 | North Texas Mean Green | | 27 | 34 | 2013-09-14 00:00:00 |
| 341 | East Carolina Pirates | | 13 | 31 | 2014-03-03 00:00:00 |
| 342 | Louisville Cardinals | | 7 | 49 | 2013-09-01 00:00:00 |
| 140 | Idaho Vandals | | 45 | 35 | 2013-09-14 00:00:00 |
| 141 | Alabama Crimson Tide | | 0 | 0 | 2014-01-01 00:00:00 |
| 142 | Illinois Fighting Illini | | 34 | 24 | 2013-09-14 00:00:00 |
| 143 | Iowa State Cyclones | | 27 | 21 | 2013-09-14 00:00:00 |
| 144 | Penn State Nittany Lions | | 34 | 31 | 2013-09-14 00:00:00 |
| 145 | Auburn Tigers | | 20 | 24 | 2013-09-14 00:00:00 |
| 146 | California Golden Bears | | 52 | 34 | 2013-09-14 00:00:00 |
| 147 | LSU Tigers | | 13 | 45 | 2013-09-14 00:00:00 |
| 148 | Middle Tennessee Blue Raiders | | 15 | 17 | 2013-09-14 00:00:00 |
| 149 | South Carolina Gamecocks | | 25 | 35 | 2013-09-14 00:00:00 |
| 150 | South Florida Bulls | | 28 | 10 | 2013-09-14 00:00:00 |
| 151 | Connecticut Huskies | | 32 | 21 | 2013-09-14 00:00:00 |
| 152 | Rice Owls | | 14 | 23 | 2013-09-14 00:00:00 |
| 153 | South Alabama Jaguars | | 24 | 31 | 2013-09-14 00:00:00 |
| 154 | New Mexico State Aggies | | 42 | 21 | 2013-09-14 00:00:00 |
| 155 | Ohio Bobcats | | 31 | 34 | 2013-09-14 00:00:00 |
| 156 | Purdue Boilermakers | | 31 | 24 | 2013-09-14 00:00:00 |
| 157 | Texas Longhorns | | 44 | 23 | 2013-09-14 00:00:00 |
| 158 | Northwestern Wildcats | | 17 | 38 | 2013-09-14 00:00:00 |
| 159 | UNLV Rebels | | 21 | 31 | 2013-09-14 00:00:00 |
| 160 | Utah Utes | | 51 | 48 | 2013-09-14 00:00:00 |
| 161 | Arizona State Sun Devils | | 30 | 32 | 2013-09-14 00:00:00 |
| 162 | North Carolina State Wolfpack | | 0 | 0 | 2013-09-19 00:00:00 |
| 163 | Fresno State Bulldogs | | 0 | 0 | 2013-09-20 00:00:00 |
| 164 | Army Black Knights | | 0 | 0 | 2013-09-21 00:00:00 |
| 165 | Central Michigan Chippewas | | 0 | 0 | 2013-09-21 00:00:00 |
| 166 | Florida Atlantic Owls | | 0 | 0 | 2013-09-21 00:00:00 |
| 167 | Eastern Michigan Eagles | | 0 | 0 | 2013-09-21 00:00:00 |
| 168 | Rice Owls | | 0 | 0 | 2013-09-21 00:00:00 |
| 169 | Florida Gators | | 0 | 0 | 2013-09-21 00:00:00 |
| 170 | Notre Dame Fighting Irish | | 0 | 0 | 2013-09-21 00:00:00 |
| 171 | Akron Zips | | 0 | 0 | 2013-09-21 00:00:00 |
| 172 | Texas Tech Red Raiders | | 0 | 0 | 2013-09-21 00:00:00 |
| 173 | San Diego State Aztecs | | 0 | 0 | 2013-09-21 00:00:00 |
| 174 | Indiana Hoosiers | | 0 | 0 | 2013-09-21 00:00:00 |
| 175 | Georgia Tech Yellow Jackets | | 0 | 0 | 2013-09-26 00:00:00 |
| 176 | Tulsa Golden Hurricane | | 0 | 0 | 2013-09-26 00:00:00 |
| 177 | BYU Cougars | | 0 | 0 | 2013-09-27 00:00:00 |
| 178 | San Jose State Spartans | | 0 | 0 | 2013-09-27 00:00:00 |
| 179 | Ball State Cardinals | | 0 | 0 | 2013-09-28 00:00:00 |
| 180 | Buffalo Bulls | | 0 | 0 | 2013-09-28 00:00:00 |
| 181 | Colorado State Rams | | 0 | 0 | 2013-09-28 00:00:00 |
| 182 | Louisiana Tech Bulldogs | | 0 | 0 | 2013-09-28 00:00:00 |
| 183 | Minnesota Golden Gophers | | 0 | 0 | 2013-09-28 00:00:00 |
| 184 | Notre Dame Fighting Irish | | 0 | 0 | 2013-09-28 00:00:00 |
| 185 | Idaho Vandals | | 0 | 0 | 2013-09-28 00:00:00 |
| 186 | Louisiana-Monroe Warhawks | | 0 | 0 | 2013-09-28 00:00:00 |
| 187 | Rice Owls | | 0 | 0 | 2013-09-28 00:00:00 |
| 188 | Texas State Bobcats | | 0 | 0 | 2013-09-28 00:00:00 |
| 189 | Western Kentucky Hilltoppers | | 0 | 0 | 2013-09-28 00:00:00 |
| 190 | Western Michigan Broncos | | 0 | 0 | 2013-09-28 00:00:00 |
| 191 | Nevada Wolf Pack | | 0 | 0 | 2013-09-28 00:00:00 |
| 192 | New Mexico Lobos | | 0 | 0 | 2013-09-28 00:00:00 |
| 193 | New Mexico State Aggies | | 0 | 0 | 2013-09-28 00:00:00 |
| 194 | Ohio State Buckeyes | | 0 | 0 | 2013-09-28 00:00:00 |
| 195 | Iowa State Cyclones | | 0 | 0 | 2013-10-03 00:00:00 |
| 196 | Louisiana-Monroe Warhawks | | 0 | 0 | 2013-10-03 00:00:00 |
| 197 | Utah Utes | | 0 | 0 | 2013-10-03 00:00:00 |
| 198 | Utah State Aggies | | 0 | 0 | 2013-10-04 00:00:00 |
| 199 | San Diego State Aztecs | | 0 | 0 | 2013-10-04 00:00:00 |
| 200 | Navy Midshipmen | | 0 | 0 | 2013-10-05 00:00:00 |
| 201 | Buffalo Bulls | | 0 | 0 | 2013-10-05 00:00:00 |
| 202 | Iowa Hawkeyes | | 0 | 0 | 2013-10-05 00:00:00 |
| 203 | Nebraska Cornhuskers | | 0 | 0 | 2013-10-05 00:00:00 |
| 204 | Troy Trojans | | 0 | 0 | 2013-10-05 00:00:00 |
| 205 | Akron Zips | | 0 | 0 | 2013-10-05 00:00:00 |
| 206 | New Mexico Lobos | | 0 | 0 | 2013-10-05 00:00:00 |
| 207 | Toledo Rockets | | 0 | 0 | 2013-10-05 00:00:00 |
| 208 | Michigan Wolverines | | 0 | 0 | 2013-10-05 00:00:00 |
| 209 | Tulane Green Wave | | 0 | 0 | 2013-10-05 00:00:00 |
| 210 | Tulsa Golden Hurricane | | 0 | 0 | 2013-10-05 00:00:00 |
| 211 | Southern Miss Golden Eagles | | 0 | 0 | 2013-10-05 00:00:00 |
| 212 | Idaho Vandals | | 0 | 0 | 2013-10-05 00:00:00 |
| 213 | Louisiana-Lafayette Ragin Cajuns | | 0 | 0 | 2013-10-05 00:00:00 |
| 214 | Arizona State Sun Devils | | 0 | 0 | 2013-10-05 00:00:00 |
| 215 | UTEP Miners | | 0 | 0 | 2013-10-05 00:00:00 |
| 216 | Northwestern Wildcats | | 0 | 0 | 2013-10-05 00:00:00 |
| 217 | Air Force Falcons | | 0 | 0 | 2013-10-10 00:00:00 |
| 218 | USC Trojans | | 0 | 0 | 2013-10-10 00:00:00 |
| 219 | Army Black Knights | | 0 | 0 | 2013-10-12 00:00:00 |
| 220 | Michigan State Spartans | | 0 | 0 | 2013-10-12 00:00:00 |
| 221 | Georgia State Panthers | | 0 | 0 | 2013-10-12 00:00:00 |
| 222 | Ohio Bobcats | | 0 | 0 | 2013-10-12 00:00:00 |
| 223 | Western Michigan Broncos | | 0 | 0 | 2013-10-12 00:00:00 |
| 224 | Ball State Cardinals | | 0 | 0 | 2013-10-12 00:00:00 |
| 225 | Colorado State Rams | | 0 | 0 | 2013-10-12 00:00:00 |
| 226 | Tulane Green Wave | | 0 | 0 | 2013-10-12 00:00:00 |
| 227 | Wisconsin Badgers | | 0 | 0 | 2013-10-12 00:00:00 |
| 228 | Wyoming Cowboys | | 0 | 0 | 2013-10-12 00:00:00 |
| 233 | Utah State Aggies | | 0 | 0 | 2013-10-12 00:00:00 |
| 229 | Florida Atlantic Owls | | 0 | 0 | 2013-10-12 00:00:00 |
| 230 | Penn State Nittany Lions | | 0 | 0 | 2013-10-12 00:00:00 |
| 231 | North Texas Mean Green | | 0 | 0 | 2013-10-12 00:00:00 |
| 232 | Texas State Bobcats | | 0 | 0 | 2013-10-12 00:00:00 |
| 234 | Western Kentucky Hilltoppers | | 0 | 0 | 2013-10-15 00:00:00 |
| 235 | Eastern Michigan Eagles | | 0 | 0 | 2013-10-19 00:00:00 |
| 236 | New Mexico Lobos | | 0 | 0 | 2013-10-19 00:00:00 |
| 237 | Western Michigan Broncos | | 0 | 0 | 2013-10-19 00:00:00 |
| 238 | Wyoming Cowboys | | 0 | 0 | 2013-10-19 00:00:00 |
| 239 | Michigan Wolverines | | 0 | 0 | 2013-10-19 00:00:00 |
| 240 | Ohio State Buckeyes | | 0 | 0 | 2013-10-19 00:00:00 |
| 241 | Louisiana Tech Bulldogs | | 0 | 0 | 2013-10-19 00:00:00 |
| 242 | Texas State Bobcats | | 0 | 0 | 2013-10-19 00:00:00 |
| 243 | Toledo Rockets | | 0 | 0 | 2013-10-19 00:00:00 |
| 244 | Notre Dame Fighting Irish | | 0 | 0 | 2013-10-19 00:00:00 |
| 245 | Boise State Broncos | | 0 | 0 | 2013-10-19 00:00:00 |
| 246 | Illinois Fighting Illini | | 0 | 0 | 2013-10-19 00:00:00 |
| 247 | New Mexico State Aggies | | 0 | 0 | 2013-10-19 00:00:00 |
| 263 | Texas State Bobcats | | 0 | 0 | 2013-10-26 00:00:00 |
| 248 | Fresno State Bulldogs | | 0 | 0 | 2013-10-19 00:00:00 |
| 249 | Arkansas State Red Wolves | | 0 | 0 | 2013-10-21 00:00:00 |
| 250 | Middle Tennessee Blue Raiders | | 0 | 0 | 2013-10-24 00:00:00 |
| 251 | Mississippi State Bulldogs | | 0 | 0 | 2013-10-24 00:00:00 |
| 252 | BYU Cougars | | 0 | 0 | 2013-10-25 00:00:00 |
| 253 | Akron Zips | | 0 | 0 | 2013-10-26 00:00:00 |
| 254 | Navy Midshipmen | | 0 | 0 | 2013-10-26 00:00:00 |
| 255 | Ohio Bobcats | | 0 | 0 | 2013-10-26 00:00:00 |
| 256 | Illinois Fighting Illini | | 0 | 0 | 2013-10-26 00:00:00 |
| 257 | Tulane Green Wave | | 0 | 0 | 2013-10-26 00:00:00 |
| 258 | Western Kentucky Hilltoppers | | 0 | 0 | 2013-10-26 00:00:00 |
| 259 | Air Force Falcons | | 0 | 0 | 2013-10-26 00:00:00 |
| 260 | Louisiana-Monroe Warhawks | | 0 | 0 | 2013-10-26 00:00:00 |
| 261 | San Jose State Spartans | | 0 | 0 | 2013-10-26 00:00:00 |
| 262 | Southern Miss Golden Eagles | | 0 | 0 | 2013-10-26 00:00:00 |
| 264 | Ohio State Buckeyes | | 0 | 0 | 2013-10-26 00:00:00 |
| 265 | North Texas Mean Green | | 0 | 0 | 2013-10-31 00:00:00 |
| 266 | Troy Trojans | | 0 | 0 | 2013-10-31 00:00:00 |
| 267 | Washington State Cougars | | 0 | 0 | 2013-10-31 00:00:00 |
| 268 | Oregon State Beavers | | 0 | 0 | 2013-11-01 00:00:00 |
| 269 | Marshall Thundering Herd | | 0 | 0 | 2013-11-02 00:00:00 |
| 270 | UAB Blazers | | 0 | 0 | 2013-11-02 00:00:00 |
| 271 | Georgia State Panthers | | 0 | 0 | 2013-11-02 00:00:00 |
| 272 | Akron Zips | | 0 | 0 | 2013-11-02 00:00:00 |
| 273 | Georgia Bulldogs | | 0 | 0 | 2013-11-02 00:00:00 |
| 274 | Indiana Hoosiers | | 0 | 0 | 2013-11-02 00:00:00 |
| 275 | Notre Dame Fighting Irish | | 0 | 0 | 2013-11-02 00:00:00 |
| 276 | UNLV Rebels | | 0 | 0 | 2013-11-02 00:00:00 |
| 277 | Idaho Vandals | | 0 | 0 | 2013-11-02 00:00:00 |
| 278 | Louisiana-Lafayette Ragin Cajuns | | 0 | 0 | 2013-11-02 00:00:00 |
| 279 | Fresno State Bulldogs | | 0 | 0 | 2013-11-02 00:00:00 |
| 280 | Toledo Rockets | | 0 | 0 | 2013-11-02 00:00:00 |
| 281 | Colorado State Rams | | 0 | 0 | 2013-11-02 00:00:00 |
| 282 | Buffalo Bulls | | 0 | 0 | 2013-11-05 00:00:00 |
| 283 | Miami RedHawks | | 0 | 0 | 2013-11-05 00:00:00 |
| 284 | Ball State Cardinals | | 0 | 0 | 2013-11-06 00:00:00 |
| 285 | Baylor Bears | | 0 | 0 | 2013-11-07 00:00:00 |
| 286 | Louisiana-Lafayette Ragin Cajuns | | 0 | 0 | 2013-11-07 00:00:00 |
| 287 | Stanford Cardinal | | 0 | 0 | 2013-11-07 00:00:00 |
| 288 | New Mexico Lobos | | 0 | 0 | 2013-11-08 00:00:00 |
| 289 | Army Black Knights | | 0 | 0 | 2013-11-09 00:00:00 |
| 290 | Marshall Thundering Herd | | 0 | 0 | 2013-11-09 00:00:00 |
| 291 | Eastern Michigan Eagles | | 0 | 0 | 2013-11-09 00:00:00 |
| 292 | Wyoming Cowboys | | 0 | 0 | 2013-11-09 00:00:00 |
| 293 | North Texas Mean Green | | 0 | 0 | 2013-11-09 00:00:00 |
| 294 | Middle Tennessee Blue Raiders | | 0 | 0 | 2013-11-09 00:00:00 |
| 295 | Louisiana Tech Bulldogs | | 0 | 0 | 2013-11-09 00:00:00 |
| 296 | Louisiana-Monroe Warhawks | | 0 | 0 | 2013-11-09 00:00:00 |
| 297 | Alabama Crimson Tide | | 0 | 0 | 2013-11-09 00:00:00 |
| 298 | San Jose State Spartans | | 0 | 0 | 2013-11-09 00:00:00 |
| 299 | Bowling Green Falcons | | 0 | 0 | 2013-11-12 00:00:00 |
| 300 | Toledo Rockets | | 0 | 0 | 2013-11-12 00:00:00 |
| 301 | Kent State Golden Flashes | | 0 | 0 | 2013-11-13 00:00:00 |
| 302 | Clemson Tigers | | 0 | 0 | 2013-11-14 00:00:00 |
| 303 | Tulsa Golden Hurricane | | 0 | 0 | 2013-11-14 00:00:00 |
| 304 | UCLA Bruins | | 0 | 0 | 2013-11-15 00:00:00 |
| 305 | Western Michigan Broncos | | 0 | 0 | 2013-11-16 00:00:00 |
| 306 | Southern Miss Golden Eagles | | 0 | 0 | 2013-11-16 00:00:00 |
| 307 | Georgia State Panthers | | 0 | 0 | 2013-11-16 00:00:00 |
| 308 | New Mexico Lobos | | 0 | 0 | 2013-11-16 00:00:00 |
| 309 | Navy Midshipmen | | 0 | 0 | 2013-11-16 00:00:00 |
| 310 | Rice Owls | | 0 | 0 | 2013-11-16 00:00:00 |
| 311 | Miami RedHawks | | 0 | 0 | 2013-11-19 00:00:00 |
| 312 | Ohio Bobcats | | 0 | 0 | 2013-11-19 00:00:00 |
| 313 | UAB Blazers | | 0 | 0 | 2013-11-21 00:00:00 |
| 314 | Air Force Falcons | | 0 | 0 | 2013-11-21 00:00:00 |
| 343 | Colorado State Rams | | 41 | 27 | 2013-09-01 00:00:00 |
| 315 | San Jose State Spartans | | 0 | 0 | 2013-11-22 00:00:00 |
| 316 | Eastern Michigan Eagles | | 0 | 0 | 2013-11-23 00:00:00 |
| 323 | Louisiana Tech Bulldogs | | 0 | 0 | 2013-11-23 00:00:00 |
| 317 | LSU Tigers | | 0 | 0 | 2013-11-23 00:00:00 |
| 318 | Notre Dame Fighting Irish | | 0 | 0 | 2013-11-23 00:00:00 |
| 319 | Southern Miss Golden Eagles | | 0 | 0 | 2013-11-23 00:00:00 |
| 320 | Tulane Green Wave | | 0 | 0 | 2013-11-23 00:00:00 |
| 321 | Utah State Aggies | | 0 | 0 | 2013-11-23 00:00:00 |
| 322 | Fresno State Bulldogs | | 0 | 0 | 2013-11-23 00:00:00 |
| 324 | San Diego State Aztecs | | 0 | 0 | 2013-11-23 00:00:00 |
| 325 | Mississippi State Bulldogs | | 0 | 0 | 2013-11-28 00:00:00 |
| 326 | Texas Longhorns | | 0 | 0 | 2013-11-28 00:00:00 |
| 327 | Marshall Thundering Herd | | 0 | 0 | 2013-11-29 00:00:00 |
| 328 | Nebraska Cornhuskers | | 0 | 0 | 2013-11-29 00:00:00 |
| 329 | LSU Tigers | | 0 | 0 | 2013-11-29 00:00:00 |
| 330 | Florida Atlantic Owls | | 0 | 0 | 2013-11-29 00:00:00 |
| 331 | San Jose State Spartans | | 0 | 0 | 2013-11-29 00:00:00 |
| 332 | Washington Huskies | | 0 | 0 | 2013-11-29 00:00:00 |
| 333 | Oregon Ducks | | 0 | 0 | 2013-11-29 00:00:00 |
| 334 | UAB Blazers | | 0 | 0 | 2013-11-30 00:00:00 |
| 335 | Georgia State Panthers | | 0 | 0 | 2013-11-30 00:00:00 |
| 336 | Utah State Aggies | | 0 | 0 | 2013-11-30 00:00:00 |
| 337 | Nevada Wolf Pack | | 0 | 0 | 2013-11-30 00:00:00 |
| 338 | Rice Owls | | 0 | 0 | 2013-11-30 00:00:00 |
| 339 | Western Kentucky Hilltoppers | | 0 | 0 | 2013-11-30 00:00:00 |
| 340 | Louisiana-Lafayette Ragin Cajuns | | 0 | 0 | 2013-11-30 00:00:00 |
| 348 | Virginia Tech Hokies | | 35 | 10 | 2013-08-31 00:00:00 |
| 345 | East Carolina Pirates | | 13 | 31 | 2013-09-05 00:00:00 |
| 346 | Boston College Eagles | | 10 | 24 | 2013-09-06 00:00:00 |
| 347 | FIU Golden Panthers | | 38 | 0 | 2013-09-06 00:00:00 |
| 349 | Ohio State Buckeyes | | 20 | 40 | 2013-08-31 00:00:00 |
| 350 | Clemson Tigers | | 35 | 38 | 2013-08-31 00:00:00 |
| 351 | Texas A&M Aggies | | 31 | 52 | 2013-01-01 00:00:00 |
| 352 | Texas A&M Aggies | | 31 | 52 | 2013-08-31 00:00:00 |
| 353 | Florida Gators | | 6 | 24 | 2013-08-31 00:00:00 |
| 354 | TCU Horned Frogs | | 37 | 27 | 2013-08-31 00:00:00 |
| 355 | Oklahoma State Cowboys | | 3 | 21 | 2013-08-31 00:00:00 |
| 356 | Notre Dame Fighting Irish | | 6 | 28 | 2013-08-31 00:00:00 |
| 357 | Texas Longhorns | | 7 | 56 | 2013-08-31 00:00:00 |
| 358 | Oklahoma Sooners | | 0 | 34 | 2013-08-31 00:00:00 |
| 359 | Michigan Wolverines | | 9 | 59 | 2013-08-31 00:00:00 |
| 360 | Nebraska Cornhuskers | | 34 | 37 | 2013-08-31 00:00:00 |
| 361 | Washington Huskies | | 6 | 38 | 2013-08-31 00:00:00 |
| 362 | UCLA Bruins | | 20 | 58 | 2013-08-31 00:00:00 |
| 363 | California Golden Bears | | 44 | 30 | 2013-08-31 00:00:00 |
| 364 | Wisconsin Badgers | | 0 | 45 | 2013-08-31 00:00:00 |
| 365 | Oregon State Beavers | | 49 | 46 | 2013-08-31 00:00:00 |
| 366 | Cincinnati Bearcats | | 7 | 42 | 2013-08-31 00:00:00 |
| 367 | Maryland Terrapins | | 10 | 43 | 2013-08-31 00:00:00 |
| 368 | North Carolina State Wolfpack | | 14 | 40 | 2013-08-31 00:00:00 |
| 369 | Iowa Hawkeyes | | 30 | 27 | 2013-08-31 00:00:00 |
| 370 | Syracuse Orange | | 23 | 17 | 2013-08-31 00:00:00 |
| 371 | Virginia Cavaliers | | 16 | 19 | 2013-08-31 00:00:00 |
| 372 | Arkansas Razorbacks | | 14 | 34 | 2013-08-31 00:00:00 |
| 373 | Auburn Tigers | | 24 | 31 | 2013-08-31 00:00:00 |
| 374 | Western Kentucky Hilltoppers | | 26 | 35 | 2013-08-31 00:00:00 |
| 375 | Marshall Thundering Herd | | 14 | 52 | 2013-08-31 00:00:00 |
| 376 | North Texas Mean Green | | 6 | 40 | 2013-08-31 00:00:00 |
| 377 | Troy Trojans | | 31 | 34 | 2013-08-31 00:00:00 |
| 378 | Southern Miss Golden Eagles | | 22 | 15 | 2013-08-31 00:00:00 |
| 379 | New Mexico Lobos | | 21 | 13 | 2013-08-31 00:00:00 |
| 380 | Virginia Cavaliers | | 59 | 10 | 2013-09-07 00:00:00 |
| 381 | Ohio State Buckeyes | | 7 | 42 | 2013-09-07 00:00:00 |
| 383 | Stanford Cardinal | | 13 | 34 | 2013-09-07 00:00:00 |
| 384 | Georgia Bulldogs | | 30 | 41 | 2013-09-07 00:00:00 |
| 385 | LSU Tigers | | 17 | 56 | 2013-09-07 00:00:00 |
| 386 | Miami Hurricanes | | 16 | 21 | 2013-09-07 00:00:00 |
| 387 | UTSA Roadrunners | | 56 | 35 | 2013-09-07 00:00:00 |
| 388 | Michigan Wolverines | | 30 | 41 | 2013-09-07 00:00:00 |
| 389 | BYU Cougars | | 21 | 40 | 2013-09-07 00:00:00 |
| 390 | Oklahoma Sooners | | 7 | 16 | 2013-09-07 00:00:00 |
| 391 | Northwestern Wildcats | | 27 | 48 | 2013-09-07 00:00:00 |
| 392 | Nebraska Cornhuskers | | 13 | 56 | 2013-09-07 00:00:00 |
| 393 | Baylor Bears | | 13 | 70 | 2013-09-07 00:00:00 |
| 394 | USC Trojans | | 10 | 7 | 2013-09-07 00:00:00 |
| 395 | Kent State Golden Flashes | | 41 | 22 | 2013-09-07 00:00:00 |
| 396 | Kentucky Wildcats | | 7 | 41 | 2013-09-07 00:00:00 |
| 397 | Michigan State Spartans | | 6 | 21 | 2013-09-07 00:00:00 |
| 398 | Penn State Nittany Lions | | 7 | 45 | 2013-09-07 00:00:00 |
| 399 | Temple Owls | | 22 | 13 | 2013-09-07 00:00:00 |
| 400 | Illinois Fighting Illini | | 17 | 45 | 2013-09-07 00:00:00 |
| 401 | Tennessee Volunteers | | 20 | 52 | 2013-09-07 00:00:00 |
| 402 | North Carolina Tar Heels | | 20 | 40 | 2013-09-07 00:00:00 |
| 403 | Ball State Cardinals | | 14 | 40 | 2013-09-07 00:00:00 |
| 404 | Tulane Green Wave | | 41 | 39 | 2013-09-07 00:00:00 |
| 405 | Missouri Tigers | | 23 | 38 | 2013-09-07 00:00:00 |
| 406 | Air Force Falcons | | 52 | 20 | 2013-09-07 00:00:00 |
| 407 | Wyoming Cowboys | | 10 | 42 | 2013-09-07 00:00:00 |
| 408 | Memphis Tigers | | 28 | 14 | 2013-09-07 00:00:00 |
| 409 | Indiana Hoosiers | | 41 | 35 | 2013-09-07 00:00:00 |
| 410 | Kansas State Wildcats | | 27 | 48 | 2013-09-07 00:00:00 |
| 411 | Ohio Bobcats | | 21 | 27 | 2013-09-07 00:00:00 |
| 412 | Tulsa Golden Hurricane | | 27 | 30 | 2013-09-07 00:00:00 |
| 413 | Auburn Tigers | | 9 | 38 | 2013-09-07 00:00:00 |
| 414 | New Mexico State Aggies | | 44 | 21 | 2013-09-07 00:00:00 |
| 415 | Oregon State Beavers | | 14 | 33 | 2013-09-07 00:00:00 |
| 416 | UTEP Miners | | 42 | 35 | 2013-09-07 00:00:00 |
| 417 | UNLV Rebels | | 58 | 13 | 2013-09-07 00:00:00 |
| 419 | Arizona Wildcats | | 38 | | 2013-09-14 00:00:00 |

What is claimed is:

1. A computer-network-compatible method of comparative ranking or rating, the method comprising the steps of:
a. aggregating information or data;
b. storing the information or data;
c. analyzing the aggregated information or data;
d. creating a least one preliminary result;
e. removing duplicates of the at least one preliminary result;
f. providing users to input custom requirements; and
g. providing at least one final result.

2. The method of claim 1, wherein aggregating information or data includes information or data from the predictions of sports software, Internet bloggers, sports analysts, and Internet users to determine a consensus of a likely outcome or result.

3. The method of claim 1, wherein the information or data is Internet-accessible.

4. The method of claim 1, wherein storing the information or data includes electronically storing the information or data in a database.

5. The method of claim 1, wherein analyzing the aggregated information or data includes using at least one algorithm.

6. The method of claim 5, wherein the at least one algorithm includes (((A+0.1*10)B*5))*10)+((C+D)/2)+((E+F+G+H+I+J)/100)/3, wherein factors A-J include team wins, team losses, strength of team schedule, and strength of team conference.

7. The method of claim 1, wherein analyzing the aggregated information or data includes weighing or assigning a relevance to the aggregated information or data based on its validity.

8. The method of claim 1, wherein analyzing the aggregated information includes data relating to the past success rate of the purveyor of the information or data.

9. The method of claim 1, wherein analyzing the aggregated information or data includes likely outcome matching based on computer modeling.

10. The method of claim 1, wherein analyzing the aggregated information or data includes the analysis of a plurality of simulated outcomes to determine a weighting or relevance factor to be applied to the at lease one result.

11. The method of claim 1, wherein aggregated information or data with higher indicia of validity are given more weight or relevance than information or data with lower indicia of validity.

12. The method of claim 1, wherein the aggregated information or data includes current social media information or data to provide at least one temporally relevant result.

13. The method of claim 1, wherein creating at least one preliminary result includes a result of the weighted or assigned relevance of the aggregated information or data.

14. The method of claim 1, wherein removing duplicates of the at least one preliminary result comprises a de-duplication process in which the system avoids producing multiple outcomes of the same event to ensure the system yields a single result in the event the analysis returns multiple results.

15. The method of claim 1, wherein providing user input requirements includes team requirements or coaching tendencies that allow the system to modify the at least one preliminary result to account for the team requirements or coaching tendencies.

16. The method of claim 1, wherein providing user input requirements include users' predictions of a result that can be adapted for analysis by an algorithm and incorporated into a result.

17. The method of claim 1, wherein providing an at least one final result includes using an algorithm to allow the system to make adjustments to the results based on pattern tendencies over time.

18. The method of claim 1, wherein providing at least on final result includes allowing the system to incorporate past results in future analyses.

19. The method of claim 1, wherein providing at least one final result includes allowing the system to incorporate past results in future analyses.

20. The method of claim 1, wherein providing at least one final result includes presenting at least one comparative result to a user.

21. The method of claim 20, wherein the at least one comparative result is compatible for presentation in web-browser software.

22. The method of claim 20, wherein the at least one comparative result includes presenting a plurality of comparative results to a user.

23. A ranking or rating system compatible with a computer network, the system comprising:
a. an event trigging the aggregation of information or data obtained from various sources and stored in a database, including information or data retrieved by a crawler server;
b. wherein the information or data is analyzed by a computer-based algorithm;
c. wherein the information or data is weighed or assigned relevance based on the parameters of the computer-based algorithm;
d. wherein the information or data is de-duplicated to eliminate inconsistent results;
e. wherein the system allows users to input information or data for analysis by the computer-based algorithm;
f. wherein the system includes a self-learning feature that allows the system to learn from prior results for future analyses and results; and
g. wherein the system presents results to a user of the system.

24. A computer-network-compatible method of comparative ranking or rating, the method comprising:
a. computer-program-code means for aggregating information or data;
b. computer-program-code means for storing the information or data;
c. computer-program-code means for analyzing the aggregated information or data;
d. computer-program-code means for creating a preliminary result;
e. computer-program-code means for removing duplicates of the preliminary result;
f. computer-program-code means for providing users to input custom requirements;
g. computer-program-code means for providing a final result; and
h. computer-program-code means for adjusting the final result to allow the system to incorporate past results in future analyses;
i. computer-program-code means for presenting results.

25. A computer-network-compatible system for comparative ranking or rating, the system comprising:
a. computer-program-code means for aggregating information or data;
b. computer-program-code means for storing the information or data;
c. computer-program-code means for analyzing the aggregated information or data;
d. computer-program-code means for creating a preliminary result;
e. computer-program-code means for removing duplicates of the preliminary result;
f. computer-program-code means for providing users to input custom requirements;
g. computer-program-code means for providing a final result; and
h. computer-program-code means for adjusting the final result to allow the system to incorporate past results in future analyses;
i. computer-program-code means for presenting results.
